(19) United States
(12) Patent Application Publication
(10) Pub. No.: US 2015/0310878 A1
(43) Pub. Date: Oct. 29, 2015

(54) METHOD AND APPARATUS FOR DETERMINING EMOTION INFORMATION FROM USER VOICE

(71) Applicant: Samsung Electronics Co., Ltd., Suwon-si (KR)

(72) Inventors: Lukasz Jakub BRONAKOWSKI, Warszawa (PL); Arleta STASZUK, Warszawa (PL); Jakub TKACZUK, Rumia (PL)

(21) Appl. No.: 14/696,649

(22) Filed: Apr. 27, 2015

(30) Foreign Application Priority Data
Apr. 25, 2014 (KR) 10-2014-0050130

(51) Int. Cl. G10L 25/48; G10L 15/08

(52) U.S. Cl. CPC G10L 25/48; G10L 15/08

(57) ABSTRACT

A method of determining emotion information from a voice is provided. The method includes receiving a voice frame obtained by converting a sound generated by a user into an electrical signal, detecting phonation information and articulation information, the phonation information being related to phonation of the user and the articulation information being related to articulation of the user, from the voice frame, and determining user emotion information corresponding to the phonation information and the articulation information.

### CROSS-REFERENCE TO RELATED APPLICATION(S)

This application claims the benefit under 35 U.S.C. §119(a) of a Korean patent application filed on Apr. 25, 2014 in the Korean Intellectual Property Office and assigned Serial number 10-2014-0050130, the entire disclosure of which is hereby incorporated by reference.

### TECHNICAL FIELD

The present disclosure relates to technology of processing and applying a voice signal.

### BACKGROUND

Recently, various services and additional functions provided by an electronic apparatus, such as a mobile device, have been gradually expanded. In order to improve an effective value of the electronic apparatus and satisfy various needs of users, various applications executable in the electronic apparatus have been developed.

The electronic apparatus may store and execute default applications, which are manufactured by a company and installed on the electronic apparatus by a manufacturing company of the electronic apparatus, and additional applications downloaded from application selling websites on the Internet, and the like. The additional applications may be developed by general developers and registered on the application selling website. Accordingly, anyone who has developed applications may freely sell the developed applications to users of the electronic apparatuses on the application selling websites. As a result, at present, tens to hundreds of thousands of free or purchasable applications are provided to the electronic apparatuses depending on the specifications of the electronic apparatuses.

Further, in order to improve convenience of the user of the electronic apparatus, development of various applications capable of detecting and/or applying a humanity of a user has been attempted.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for rapidly detecting information related to emotion of a user from a sound created by the user.

Another aspect of the present disclosure is to provide a method and an apparatus for detecting information more directly related to the emotions of a user from a sound created by the user.

In accordance with an aspect of the present disclosure, a method of determining emotion information from a voice is provided. The method includes receiving a voice frame obtained by converting a sound generated by a user into an electrical signal, detecting phonation information and articulation information, the phonation information being related to phonation of the user and the articulation information being related to articulation of the user, from the voice frame, and determining user emotion information corresponding to the phonation information and the articulation information.

In accordance with another aspect of the present disclosure, an electronic apparatus is provided. The apparatus includes a microphone configured to convert an input voice signal into an electrical signal, a speaker configured to output the electrical signal, a screen configured to display information, at least one controller configured to process a program for determining user emotion information, in which the program for determining the user emotion information includes commands for converting the electrical signal into a voice frame, detecting phonation information and articulation information, the phonation information being related to phonation of the user and the articulation information being related to articulation of the user, from the voice frame, and determining the user emotion information corresponding to the phonation information and the articulation information.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a flowchart illustrating an order of operations of a method of determining emotion information from a voice according to an embodiment of the present disclosure;

FIG. 2 is a diagram illustrating an example of a mechanism of generating a sound used in a method of determining emotion information from a voice according to an embodiment of the present disclosure;

FIG. 3 is a flowchart illustrating an order of a process of detecting information related to a level of tension of glottides of a user included in a method of determining emotion information from a voice according to an embodiment of the present disclosure;

FIG. 4 is a diagram illustrating an example of an order of a frame region selection process included in a method of determining emotion information from a voice according to an embodiment of the present disclosure;

FIG. 5 is a diagram illustrating an example of an order of a method of determining emotion information from a voice according to an embodiment of the present disclosure; and

FIG. 6 is a block diagram illustrating a configuration of an electronic apparatus to which a method of determining emotion information from a voice is applied according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Although the terms including an ordinal number such as first, second, etc., can be used for describing various elements, the structural elements are not restricted by the terms. The terms are only used to distinguish one element from another element. For example, without departing from the scope of the present disclosure, a first structural element may be named a second structural element. Similarly, the second structural element also may be named the first structural element. The terms used in this application merely are for the purpose of describing particular embodiments and are not intended to limit the present disclosure. Singular forms are intended to include plural forms unless the context clearly indicates otherwise.

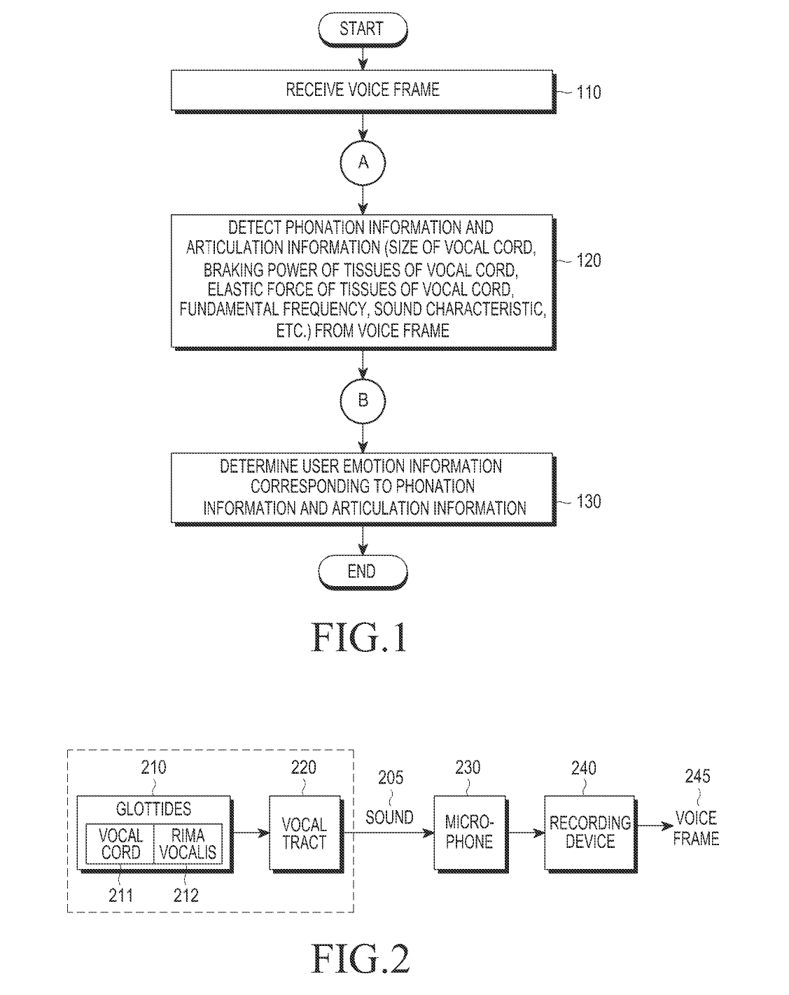

FIG. 1 is a flowchart illustrating an order of operations of a method of determining emotion information from a voice according to an embodiment of the present disclosure.

Referring to FIG. 1, a method of determining emotion information from a voice, according to an embodiment of the present disclosure, includes operation 110 of receiving a voice frame, operation 120 of detecting phonation information and articulation information from the voice frame, and operation 130 of determining user emotion information corresponding to the phonation information and the articulation information.

The methods of determining emotion information from a voice according to embodiments of the present disclosure may similarly include detecting emotion information indicating an emotional state of a user from a sound generated from and/or by the user. Accordingly, operation 110 is a process of receiving the voice frame, which is a target for the detection of the emotion information. The voice frame determined in operation 110 may be a voice frame obtained by receiving a sound generated by the user in real time, and converting the received sound to an electrical signal. Further, the voice frame input in operation 110 should have a length to the extent that information for extracting the emotion information is detectable. Accordingly, the voice frame may be received according to a time unit, for example, a time unit of 0.5 seconds, in which the information for extracting the emotion information is detectable.

Although it has been described that operation 110 of receiving the voice frame is the reception of the voice frame in real time in the embodiment of the present disclosure, the present disclosure is not limited thereto, and operation 110 of receiving the voice frame may be performed by merely receiving of the voice frame, which is a target of the detection of the emotion information, as a predetermined voice frame. For example, in operation 110 of receiving the voice frame, even though the sound is not received in real time, a voice frame obtained by converting a sound generated by the user into an electrical signal to be stored as the voice frame may be received as a matter of course.

Next, operation 120 includes detecting the phonation information related to phonation of the user and the articulation information related to articulation of the user from the voice frame. Furthermore, operation 130 includes determining the user emotion information corresponding to the phonation information and the articulation information.

FIG. 2 is a diagram illustrating an example of a mechanism of generating a sound used in a method of determining emotion information from a voice according to an embodiment of the present disclosure.

Referring to FIG. 2, a sound of the user may be generated by a body organ included in the body of the user, and the body organ may include glottides 210 and a vocal tract 220. The glottides 210 may include a vocal cord 211 and a rima vocalis 212 connected with an airway to form an echo chamber of air and to generate a sound wave while allowing air spurted from the airway to pass through. Further, the vocal tract 220 is included between the glottides 210 of the user to output a sound 205 of the user by filtering the sound wave output from the glottides while allowing the sound wave to pass through the vocal tract 220. In the meantime, a sound 205 output through a mouth of the user may be input into a microphone 230 provided in the electronic apparatus, and the microphone 230 converts the sound 205 into an electrical signal, and a recording device 240 samples the converted electrical signal according to a time unit to generate a voice frame 245. A characteristic of the voice frame 245 may be analyzed, and the phonation information, which is related to the phonation of the user, and the articulation information, which is related to the articulation of the user, may be determined considering the mechanism of the generating of the voice frame 245.

The phonation information may include information related to the glottides 210 which generate the sound wave. For example, the phonation information may include information about at least one of a size of the vocal cord 211, braking power of tissues of the vocal cord 211, elastic force of the tissues of the vocal cord 211, and coupling stiffness coefficients. Information about the size of the vocal cord 211, the braking power of the tissues of the vocal cord 211, the elastic force of the tissues of the vocal cord 211, and the coupling stiffness coefficients may be obtained by reversely filtering the voice frame 245 considering the mechanism of generating the sound 205. The determined information about the size of the vocal cord 211, the braking power of the tissues of the vocal cord 211, the elastic force of the tissues of the vocal cord 211, and the coupling stiffness coefficients determined may include a nonlinear characteristic of the tissues of the vocal cord 211.

Further, the phonation information may further include information about a fundamental frequency included in the voice frame 245. The fundamental frequency may be obtained by using a Linear Frequency Cepstral Coefficient (LFCC).

Further, the articulation information may include information related to the vocal tract 220, which generates the sound 205 by filtering the sound wave. For example, the articulation information may include a sound characteristic of the voice frame 245. The sound characteristic included in the articulation information may be obtained by using a Mel-frequency Cepstral Coefficients (MFCC).

Further, the sound characteristic included in the articulation information may be detected by using an audio contents analysis method performed according to standards of Motion Picture Expert Group-7 (MPEG-7) standard.

For example, the sound characteristic included in the articulation information may include at least one of characteristics regulated in the MPEG-7 standard. Accordingly, the sound characteristic included in the articulation information may be detected through an encoding and/or decoding operation based on the MPEG-7 standard.

Hereinafter, examples of the characteristics regulated in the MPEG-7 standard are described below:
Basic: Instantaneous waveform and power values;
Basic spectral: Log-frequency power spectrum and spectral features, for example, spectral centroid, spectrum spread, and spectral flatness;
Signal parameters: Fundamental frequency and harmonicity of signals;
Temporal timbral: Log attack time and temporal centroid;
Spectral timbral: Spectrum properties specialized in a linear frequency space; and
Spectral basis representations: a plurality of properties used in connection with sound recognition for projections to a low-dimensional space, such as audio spectrum basis and audio spectrum projection.

Further, at least one property selected from the properties regulated in the MPEG-7 may be used in an analysis of the audio contents in a time-frequency domain. The properties used in the analysis of the audio contents will be described below:
Audio spectrum envelope: represents a short time power spectrum having log spectrum intervals;
Audio spectrum centroid: describes the center of a spectrum power density, and thus may rapidly determine a predominant low/high part of the spectrum from the analyzed signal;
Audio spectrum spread: indicates a part of the spectrum which is closely positioned to the Audio spectrum centroid, and enables pure tones to be discriminated from sounds close to typical noise;
Spectral flatness measure: indicates a tonal aspect of an audio signal, and thus may be used as a reference for discrimination between a signal component closer to a voice and a signal component more close to noise;
Spectral crest factor: related to a tone aspect of an audio signal, wherein, instead of a calculation of an average value for a numerator, a maximum value is calculated, that is, a ratio between maximum spectrum power within a frequency band and average power thereof is determined as the spectral crest factor;
Audio spectrum Flatness: designates flatness of a power spectrum of signals within the predetermined number of frequency bands; and
Harmonic spectral centroid: similar to the audio spectrum centroid, but is operated only at a harmonic part of an analyzed waveform.

In the meantime, a characteristic of a sound output from the body organ of the user may be differently exhibited according to an emotional state of the user. Considering this, a database, hereinafter, referred to as an “emotion information database”, may be configured by matching the characteristic of the sound and emotion information about the emotional state of the user. Then, the sound output from the body organ of the user is detected, and the emotion information corresponding to the detected sound may be determined from the emotion information database. In operation 130 of FIG. 1, the user emotion information corresponding to the phonation information and the articulation information may be determined based on the mechanism described above.

As described above, emotion of the user may be accurately detected by the method of determining emotion information from a voice, according to an embodiment of the present disclosure. Particularly, according to the method described according to FIGS. 1 and 2, information related to emotion of the user may be accurately and rapidly detected by using the phonation information and the articulation information, and user emotion information may be rapidly and accurately determined based on the detected information.

Further, the emotions of the user may influence a level of tension of the glottides 210 of the user, and the level of tension of the glottides 210 may be differently exhibited according to the type of emotion of the user, for example, anger, sadness, and joy. Accordingly, in order to accurately and rapidly detect information related to the emotion of the user, operation 120, as illustrated in FIG. 1, of determining the phonation information and the articulation information may include a process of detecting information related to the level of tension of the glottides 201 of the user.

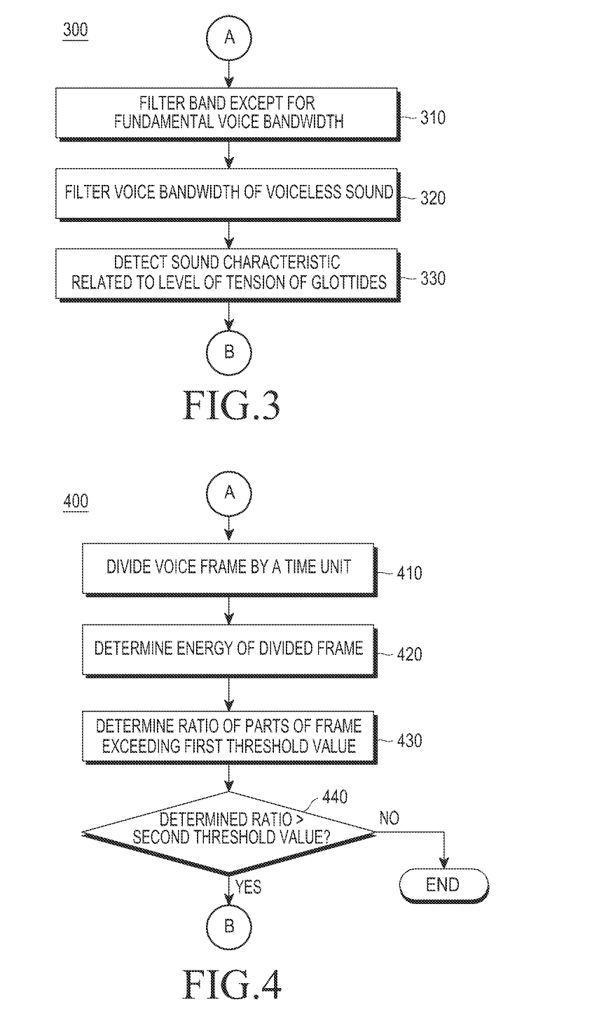

FIG. 3 is a flowchart illustrating an order of a process of detecting information related to a level of tension of glottides of a user included in a method of determining emotion information from a voice according to an embodiment of the present disclosure.

Referring to FIG. 3, a process 300 of detecting information related to the level of tension of the glottides 210 of the user includes operation 310 of filtering a band except for a fundamental voice bandwidth, operation 320 of filtering a voice bandwidth of a voiceless sound, and operation 330 of detecting a sound characteristic related to a level of tension of the glottides 210.

Operation 310 of filtering the band except for the fundamental voice bandwidth is a process of detecting a fundamental bandwidth of the sound 205 of the user, and may be a process of detecting a voice signal of the fundamental bandwidth of the sound 205 of the user. For example, operation 310 may be a process of filtering a voice signal of another bandwidth, that is, filtering a voice signal other than the voice signal of the fundamental bandwidth, for example, a band with 60 kHz to 400 Hz, of the sound 205.

Further, operation 320 of filtering the voice bandwidth of the voiceless sound is a process of removing noise, which may be a disturbance, to detect a level of tension of the glottides 210 of the user for a voiceless sound, for example, “s”, “sh”, and “c”, and may be a process of filtering a signal of a voice band related to the voiceless sound in the voice frame 245 that is filtered in a band via operation 310.

In the meantime, operation 330 of detecting the sound characteristic related to the level of tension of the glottides 210 may be a process of detecting a parameter from the voice frame 245 filtered through operations 310 and 320, wherein the parameter may be used to detect a level of tension of the glottides 210 of the user, and determining a level of tension of the glottides 210 of the user. For example, the parameter, which may be used to detect the level of tension of the glottides 210 of the user, may be include the size of the vocal cord 211, the braking power of tissues of the vocal cord 211, the elastic force of the tissues of the vocal cord 211, and the like.

Further, in order to more rapidly detect the emotion information, the method, according to an embodiment of the present disclosure, may further include a process of detecting a region, hereinafter, referred to as a “frame region selection process”, the detected region including the sound characteristic of the level of tension of the glottides 210.

FIG. 4 is a diagram illustrating an example of an order of a frame region selection process included in a method of determining emotion information from a voice according to an embodiment of the present disclosure.

Referring to FIG. 4, a frame region selection process 400 may include operation 410 of dividing an input voice frame by a time unit, operation 420 of determining an energy of the divided input voice frame, hereinafter, referred to as a “divided frame”, operation 430 of determining a ratio of parts of the divided frame having an energy level exceeding an energy threshold value, i.e., a first threshold value, and operation 440 of comparing the determined ratio of the parts of the divided frame exceeding the first threshold value with a second threshold value, and determining whether the ratio exceeds the second threshold value.

Further, the frame region selection operation 400 may include operation 120 (see FIG. 1) of detecting the phonation information and the articulation information from a voice frame, of which the ratio exceeds the second threshold value, which may occur if the determined ratio exceeds the second threshold value as determined in operation 440.

The dividing of the voice frame is acceptable if the divided voice frame has a size large enough to determine whether the sound of the user is included in the voice frame. Accordingly, in operation 410, the voice frame may be divided by the time unit in order to determine whether the sound of the user is included in the voice frame. For example, in a case where a time unit of the voice frame is 0.5 second and the sampling is performed on the voice frame at a rate of 16 kHz, then the voice frame may be divided into 59 parts of the divided frame.

In operation 420, energy for the divided frame unit may be determined.

In the meantime, operation 430 is included in order to determine whether the sound of the user is included in the divided frame by determining the ratio of the parts of the divided frame exceeding the first threshold value. Accordingly, a size of the first threshold value used in operation 430 may be set based on whether the sound of the user is included in the divided frame.

When the sound of the user is included within the voice frame as indicated by a number of the parts of the divided frame exceeding the first threshold value, then the phonation information and the articulation information may be more accurately detected in order to detect the user emotion information. Accordingly, in operation 440, it is determined whether the sound of the user is included in the voice frame by the ratio large enough to detect the phonation information and the articulation information by determining whether the determined ratio exceeds the second threshold value. Accordingly, the second threshold value may be set considering the ratio by which the phonation information and the articulation information may be detected. For example, the second threshold value may be set to 30%, or a ratio, like 30%, may be set to a number, for example, 17, determined considering the number of parts of the divided frame, for example 59, included in the voice frame.

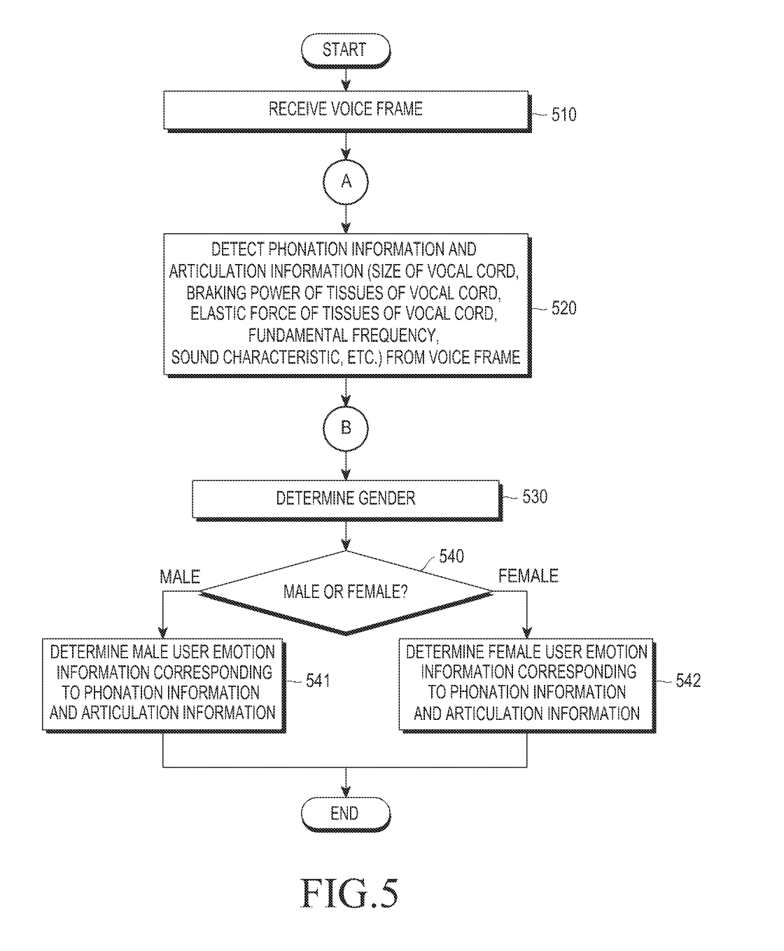

FIG. 5 is a diagram illustrating an example of an order of a method of determining emotion information from a voice according to an embodiment of the present disclosure.

Referring to FIG. 5, the method according to an embodiment of the present disclosure may be similarly configured to an embodiment of the present disclosure described above, and may include processes described above according to an embodiment of the present disclosure. However, the method according to the embodiment of the present disclosure, as shown in FIG. 5, includes a process of determining a gender of a user by using phonation information and articulation information determined from a voice frame, in which user emotion information may be determined according to the determined gender of the user.

Particularly, the method of determining emotion information from a voice according to the embodiment of the present disclosure, as shown in FIG. 5, includes operation 510 of receiving a voice frame, operation 520 of detecting phonation information and articulation information from the voice frame, operation 530 of determining the gender of a user by using the phonation information and the articulation information, and operations 540, 541, and 542 of determining emotion information by considering the gender of the user.

Operation 510 of receiving the voice frame, and operation 520 of detecting the phonation information and the articulation information from the voice frame are respectively similar to operation 110 (see FIG. 1) of receiving the voice frame and operation 120 (see FIG. 1) of detecting the phonation information and the articulation information from the voice frame included in the method according to the embodiment of the present disclosure as shown in FIG. 1. Further, operation 520 of detecting the phonation information and the articulation information may include at least one of operation 300 (see FIG. 3) of detecting the information related to the level of tension of the glottides of the user, and the frame region selection process 400 which is aforementioned with reference to FIG. 4.

In operation 530 of determining the gender of the user by using the phonation information and the articulation information, the gender of the user may be determined by using the phonation information and the articulation information determined in operation 520. Particularly, the gender of the user may be determined by using at least one of pieces of information about energy of the divided frame, a fundamental frequency, formants, an MFCC, power spectrum density, and a frequency at maximum power, from among the information detected in operation 520 of detecting the phonation information and the articulation information. Further, in operation 530, the gender of the user may also be determined by using the MFCC, a sound characteristic related to a level of tension of the glottides, and the characteristics regulated in the MPEG-7 standard.

A characteristic of the sound output from a body organ of the user may be differently exhibited according to the gender of the user, and a characteristic of emotion information, which is exhibited according to the gender, may also be differently exhibited. Considering this, a database may be configured by matching the characteristic of the sound according to the gender of the user and information about an emotional state of the user, that is, emotion information. For example, the database may be divided into a male emotion information DB, in which a sound characteristic and emotion information about a male are configured as a database, and a female emotion information DB, in which a sound characteristic and emotion information about a female are configured as a database.

The emotion information may be determined by considering the gender of the user in operations 540, 541, and 542 of determining the emotion information. Particularly, in operation 540, when the gender of the user determined in operation 530 is a male, the method proceeds to operation 541, and when the gender of the user determined in operation 530 is a female, the method proceeds to operation 542. In operation 541, male user emotion information corresponding to the phonation information and the articulation information may be determined from the male emotion information DB. In the meantime, in operation 542, female user emotion information corresponding to the phonation information and the articulation information may be determined from the female emotion information DB.

As described above, emotion information may be more accurately detected by using the sound characteristic, which is differently exhibited according to the gender of the user, by the method of determining emotion information from a voice according to an embodiment of the present disclosure.

In the method of determining the emotion information from the voice according to the embodiment of the present disclosure, as illustrated in FIG. 5, the gender of the user is determined by using the phonation information and the articulation information, and the emotion information is determined by considering the gender of the user as described above. However, the present disclosure is not limited thereto, and according to an embodiment of the present disclosure, a category of the user may be classified by using the phonation information and the articulation information, or the user emotion information may be determined by considering the category of the user classified as described above. For example, the user emotion information may also be determined by further determining an age group of the user, and the like, by using the phonation information and the articulation information, and considering the age group.

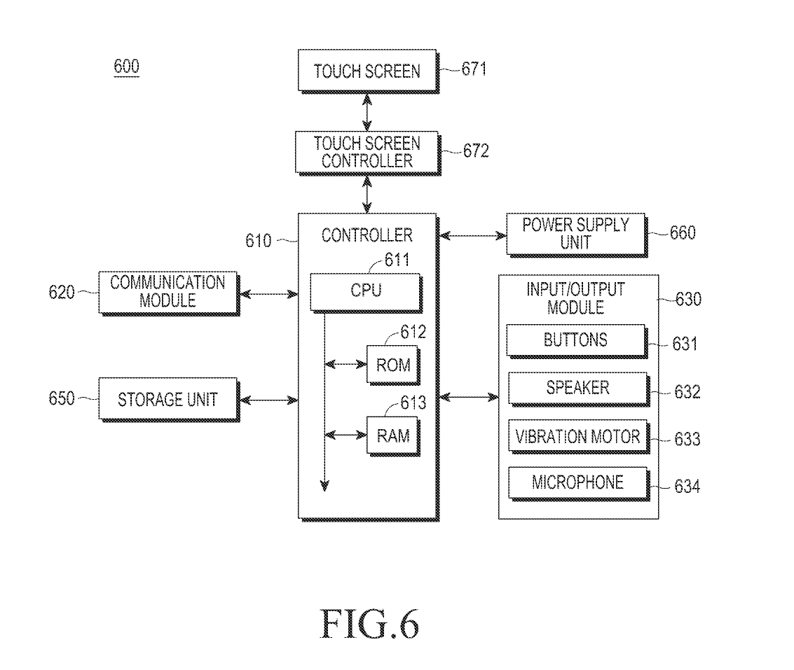

FIG. 6 is a block diagram illustrating a configuration of an electronic apparatus to which a method of determining emotion information from a voice is applied according to an embodiment of the present disclosure.

Referring to FIG. 6, an electronic apparatus 600 includes a controller 610, a communication module 620, an input/output module 630, a storage unit 650, a power supply unit 660, a touch screen 671, and a touch screen controller 672.

The controller 610 may include a Central Processing Unit (CPU) 611, a Read-Only Memory (ROM) 612 which stores a control program for controlling the electronic apparatus 600, and a Random Access Memory (RAM) 613 which stores a signal and/or data received from a source external to the electronic apparatus 600 and/or is used as a memory area for a task performed by the electronic apparatus 600. The CPU 611, the ROM 612 and the RAM 613 may be interconnected by an internal bus (not shown). Also, the controller 610 may control the communication module 620, the input/output module 630, the storage unit 650, the power supply unit 660, the touch screen 671, and the touch screen controller 672. Further, the controller 610 may be configured by a single core, or may be configured by a multi-core, such as a dual-core, a triple-core, a quad-core, or any suitable number of cores. It is a matter of course that the number of cores may be variously determined according to characteristics of a terminal by those having ordinary knowledge in the technical field of the present disclosure.

The communication module 620 may include at least one of a cellular module (not shown), a wireless Local Area Network (LAN) module (not shown), and a short-range communication module (not shown).

The cellular module connects the electronic apparatus 600 to an external device through mobile and/or cellular communication by using at least one antenna (not shown) according to the control of the controller 610. The cellular module transmits and receives wireless signals for voice calls, video calls, Short Message Service (SMS) messages, Multimedia Messaging Service (MMS) messages, and the like to/from an external electronic apparatus (not shown), such as a mobile phone, a smart phone, a tablet Personal Computer (PC) or another device which may perform mobile and/or cellular communication with the electronic apparatus 600.

According to the control of the controller 610, the wireless LAN module may be connected to the Internet at a place where a wireless Access Point (AP) (not shown) is installed. The wireless LAN module supports a wireless LAN provision of the Institute of American Electrical and Electronics Engineers (IEEE), that being IEEE 802.11x. The wireless LAN module may operate a Wi-Fi Positioning System (WPS) which identifies location information about a terminal, such as the electronic apparatus 600, including the wireless LAN module by using position information provided by a wireless AP to which the wireless LAN module is wirelessly connected.

The short-range communication module is a module which allows the electronic apparatus 600 to perform short-range communication wirelessly with another electronic device under the control of the controller 610, and may perform communication based on a short-range communication scheme, such as Bluetooth communication, Infrared Data Association (IrDA) communication, Wi-Fi Direct communication, and Near Field Communication (NFC).

The input/output module 630 includes at least one of buttons 631, a speaker 632, a vibration motor 633, and a microphone 634.

The buttons 631 may be disposed on a front surface, a lateral surface and/or a rear surface of a housing of the apparatus 600, and may include at least one of a power/lock button (not shown), a volume button (not shown), a menu button (not shown), a home button (not shown), a back button (not shown), and a search button (not shown).

The speaker 632 may output sounds corresponding to various signals, for example, a wireless signal and a broadcasting signal, of the cellular module, the wireless LAN module, and the short-range communication module to the outside of the electronic apparatus 600 under the control of the controller 610. The electronic apparatus 600 may include multiple speakers (not shown). The speaker 632 and/or the multiple speakers may be disposed at an appropriate position and/or appropriate positions of the housing of the electronic apparatus 600 for directing output sounds.

At least one speaker 632 may be disposed at an appropriate position and/or appropriate positions of the housing of the apparatus 600.

According to the control of the controller 610, the vibration motor 633 may convert an electrical signal into a mechanical vibration. One of the vibration motor 633 and/or a plurality of the vibration motor 633 may be formed within the housing.

The microphone 634 may convert a sound generated by the user into an electrical signal and may provide the electrical signal to the controller 610, and the controller 610 may generate and store the voice frame by using the electrical signal provided from the microphone 634.

The storage unit 650 may store signals and/or data input/output in response to the operation of the communication module 620, the input/output module 630, and/or the touch screen 671 under the control of the control unit 610. The storage unit 650 may store control programs and applications for controlling the electronic apparatus 600 and/or the controller 610.

Particularly, the storage unit 650 may store a control program and/or an application for processing the method of determining the emotion information from the voice according to an embodiment of the present disclosure. The control program and/or the application for processing the method of determining the emotion information from the voice may include commands for processing an input of the voice frame, for detecting phonation information and articulation information from the voice frame, and for determining user emotion information corresponding to the phonation information and the articulation information. Further, the storage unit 650 may store data, for example, the voice frame, the phonation information, the articulation information, and the emotion information, generated during the processing of the method of determining the emotion information from the voice. Further, the storage unit 650 may store the emotion information database configured by matching the data, for example, the sound characteristic of the user, used for processing the method of determining the emotion information from the voice and the emotion information on the emotional state of the user.

According to an embodiment of the present disclosure, the term “storage unit” includes the storage unit 650, the ROM 612 and/or the RAM 613 within the controller 610, and/or a memory card (not shown), for example, an SD card and a memory stick, mounted in the electronic apparatus 600. The storage unit may include a non-volatile memory, a volatile memory, a Hard Disk Drive (HDD), a Solid State Drive (SSD), and the like.

According to the control of the controller 610, the power supply unit 660 may supply power to at least one battery (not shown) disposed in the housing of the apparatus 600. The at least one battery may supply power to the electronic apparatus 600. Also, the power supply unit 660 may supply power provided by an external power source (not shown) to the electronic apparatus 600 through a wired cable connected to a connector included in the electronic apparatus 600. Further, the power supply unit 660 may supply power wirelessly provided by an external power source to the electronic apparatus 600 through a wireless charging technology.

The touch screen 671 may display a User Interface (UI) corresponding to various services, for example, a telephone call, data transmission, broadcasting, and photographing, to the user based on an Operating System (OS) of the electronic apparatus 600. The touch screen 671 may transmit an analog signal corresponding to at least one touch, which is input into the UI, to the touch screen controller 672. The touch screen 671 may receive at least one touch from the user's body part, for example, fingers including a thumb, and/or an input device, for example, a stylus pen, capable of making a touch. Also, the touch screen 671 may receive a continuous movement of one touch in the at least one touch. The touch screen 671 may transmit an analog signal corresponding to the continuous movement of the one touch to the touch screen controller 672.

The touch screen 671 may be implemented in, for example, a resistive type, a capacitive type, an infrared type, and/or an acoustic wave type.

Meanwhile, the touch screen controller 672 controls an output value of the touch screen 671 so that display data provided by the controller 610 may be displayed on the touch screen 671. Then, the touch screen controller 672 converts an analog signal received from the touch screen 671 into a digital signal, for example, X and Y coordinates, and provides the digital signal to the controller 610. The controller 610 may control the touch screen 671 by using the digital signal received from the touch screen controller 671. For example, the controller 610 may allow a user to select or execute a shortcut icon (not shown) displayed on the touch screen 671 in response to a touch event or a hovering event. Further, the touch screen controller 672 may be included in the controller 610.

The methods according to the various embodiments of the present disclosure may be implemented in the form of program commands executed through various computer means to be recorded in a non-volatile and/or non-transitory computer readable medium. The computer readable recording medium may include a program command, a data file, and a data structure independently or in combination. The program commands recorded in the medium may be specially designed and configured for the present disclosure, or may be known to and usable by those skilled in the field of computer software.

Further, the methods according to the various embodiments of the present disclosure may be implemented in a program command form and stored in the storage unit 650 of the electronic apparatus 600, and the program command may be temporarily stored in the RAM 613 included in the controller 610 in order to execute the methods according to the various embodiments of the present disclosure. Accordingly, the controller 610 may perform the control of hardware components included in the electronic apparatus 600 in response to the program commands according to the methods of the various embodiments of the present disclosure, temporarily and/or continuously store the data produced during the execution of the methods according to the various embodiments of the present disclosure in the storage unit 650, and provide UIs needed for executing the methods according to the various embodiments of the present disclosure to the touch screen controller 672.

It may be appreciated that the various embodiments of the present disclosure may be implemented in software, hardware, or a combination thereof. Any such software may be stored, for example, in a volatile and/or a non-volatile storage device, such as a ROM, a memory such as a RAM, a memory chip, a memory device, a memory such as an IC, and/or an optical or magnetic recordable and machine-readable medium, e.g., a computer-readable medium, such as a Compact Disk (CD), a Digital Versatile Disk (DVD), a magnetic disk, and/or a magnetic tape, regardless of its ability to be erased or its ability to be re-recorded. A web widget manufacturing method can be realized by a computer and/or a portable terminal including a controller and a memory, and it can be seen that the memory corresponds to an example of the storage medium which is suitable for storing a program and/or programs including instructions by which the various embodiments of the present are realized, and is machine readable. Accordingly, a program for a code implementing the apparatus and method described in the appended claims of the specification and a machine-readable and/or computer-readable storage medium for storing the program. Further, the program may be electronically transferred by a predetermined medium such as a communication signal transferred through a wired or wireless connection, and the present disclosure appropriately includes equivalents of the program.

Further, the device can receive the program from a program providing apparatus connected to the device wirelessly and/or through a wire and may store the received program. The device for providing a program may include a memory that stores a program including instructions which instruct the electronic device to perform a previously-set method for outputting a sound, information used for the method for outputting a sound, and the like, a communication unit that performs wired and/or wireless communication, and a controller that controls the transmission of a program. The program providing apparatus may provide the program to the electronic apparatus when receiving a request for providing the program from the electronic apparatus. Further, even when there is no request for providing the program from the electronic apparatus, for example, when the electronic apparatus is located within a particular place, the program providing apparatus may provide the program to the electronic apparatus through a wire and/or wirelessly.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of determining emotion information from a voice, the method comprising:
receiving a voice frame obtained by converting a sound generated by a user into an electrical signal;
detecting phonation information and articulation information, the phonation information being related to phonation of the user and the articulation information being related to articulation of the user, from the voice frame; and
determining user emotion information corresponding to the phonation information and the articulation information.

2. The method of claim 1, wherein the phonation information includes information related to glottides of the user.

3. The method of claim 1, wherein the phonation information includes at least one of information about a size of a vocal cord of the user, information about braking power of tissues of the vocal cord of the user, and information about an elastic force of the tissues of the vocal cord of the user.

4. The method of claim 1, wherein the phonation information includes a fundamental frequency of the voice frame.

5. The method of claim 1, wherein the articulation information includes information related to a vocal tract of the user.

6. The method of claim 1, wherein the articulation information includes a sound characteristic of the voice frame.

7. The method of claim 1, wherein the detecting of the phonation information and the articulation information comprises detecting information related to a level of tension of glottides of the user.

8. The method of claim 7, wherein the detecting of the information related to the level of tension of the glottides comprises:
filtering noise except for a fundamental frequency of the voice frame; and
filtering a band of a voiceless sound.

9. The method of claim 7, wherein the detecting of the information related to the level of tension of the glottides includes:
generating a divided frame by dividing the voice frame by a time unit;
determining energy of the divided frame;
determining a ratio of parts of the divided frame that have an energy level equal to or greater than a first threshold value; and
detecting information related to the level of tension of the glottides of the user from a voice frame in which the determined ratio exceeds a second threshold value.

10. The method of claim 1, further comprising:
determining a gender of the user by using at least one piece of information corresponding to the phonation information and the articulation information,
wherein the determining of the user emotion information includes determining the user emotion information by using the at least one piece of information corresponding to the phonation information and the articulation information.

11. The method of claim 1, wherein the detecting of the phonation information and the articulation information includes dividing the voice frame by a time unit.

12. An electronic apparatus comprising:
a microphone configured to convert an input voice signal into an electrical signal;
a speaker configured to output the electrical signal;
a screen configured to display information; and
at least one controller configured to process a program for determining user emotion information,
wherein the program for determining the user emotion information includes commands for:
converting the electrical signal into a voice frame,
detecting phonation information and articulation information, the phonation information being related to phonation of the user and the articulation information being related to articulation of the user, from the voice frame, and
determining the user emotion information corresponding to the phonation information and the articulation information.

13. The electronic apparatus of claim 12, wherein the phonation information includes information related to glottides of the user.

14. The electronic apparatus of claim 13, wherein the phonation information includes at least one of information about a size of a vocal cord of the user, information about braking power of tissues of the vocal cord of the user, and information about an elastic force of the tissues of the vocal cord of the user.

15. The electronic apparatus of claim 12, wherein the articulation information includes information related to a vocal tract of the user.

16. The electronic apparatus of claim 12, wherein the program for determining the user emotion information further includes commands for:
filtering noise except for a fundamental frequency of the voice frame, and
filtering a band of a voiceless sound.

17. The electronic apparatus of claim 12, wherein the program for determining the user emotion information further includes commands for:
generating a divided frame by dividing the voice frame by a time unit,
determining a ratio of parts of the divided frame that have an energy level equal to or greater than a first threshold value, and
detecting information related to the level of tension of glottides of the user from a voice frame in which the determined ratio exceeds a second threshold value.

18. The electronic apparatus of claim 12, further comprising a storage unit configured to store a database, which includes the phonation information, the articulation information, and the user emotion information corresponding to the phonation information and the articulation information.

19. The electronic apparatus of claim 12, wherein the program for determining the user emotion information further includes commands for:
determining a gender of the user by using at least one piece of information corresponding to the phonation information and the articulation information, and
determining the user emotion information by using the at least one piece of information corresponding to the phonation information and the articulation information.

20. The electronic apparatus of claim 12, further comprising a storage unit configured to store a first database including emotion information about a first gender corresponding to the phonation information and the articulation information, and to store a second database including emotion information about a second gender corresponding to the phonation information and the articulation information.
